(19) United States
(12) Patent Application Publication
(10) Pub. No.: US 2006/0253388 A1
(43) Pub. Date: Nov. 9, 2006

(54) Financial transaction system

(76) Inventor: Dale C. Newton, Macon, GA (US)

Correspondence Address: GEORGE R. REARDON, 3356 STATION COURT, LAWRENCVILLE, GA, 30044, US

(21) Appl. No.: 11/120,479

(22) Filed: May 3, 2005

(51) Int. Cl. G06Q 40/00

(52) U.S. Cl. 705/39

(57) ABSTRACT

A financial transaction system is disclosed. The financial transaction system relates to a method of enabling the transactions from usage of a credit card or debit card to initiate other processes, e.g. intelligence/counter-intelligence espionage, real-time documentation of business related expenses, security system linkage to credit card based alerting system.

### BACKGROUND OF THE INVENTION

The present invention relates to a financial transaction system. In particular, the present invention relates to a method of enabling the transactions from usage of a credit card or ATM card to initiate other processes, e.g. intelligence/counter-intelligence espionage activities, real-time processing of expenses and security system linkage to a credit card based alerting system.

The first problem that exists involves the field of intelligence/counter-intelligence operations and espionage work. The need exists to support the secretive communication need of agents in the field. In particular, it is desired to reduce the risk of compromising the identity of an agent if and when they contact each other or need to send/receive certain sensitive information. By using a uniquely identified financial card, e.g. a credit card or debit card, an agent could have the capability of engaging in what appears to be a routine financial transaction, e.g. paying for a meal, without arousing any suspicion. This could be the basis for communicating to the agent's agency. In addition to providing an additional layer of protection and cloak of secrecy for an agency and its agents, this could possibly reduce the requirements needed by an agency to monitor the whereabouts of its agents. Furthermore, if an agent is scheduled to meet with an enemy operative at a designated time and place that has been communicated to the agent's agency, but the meeting place needs to be changed at the very last minute, then the agent has the opportunity to negotiate to meet in a location where the agent can use their credit card to relay this change in location back to their agency, who may be monitoring the activities of the agent and need to know about this unexpected change of venue.

A second problem involves the real-time processing of expenses, e.g. accounting-related data and documentation of business expenses, as well as tax data. During the course of a business person's frequent travels, the business person has to keep up with and preserve a myriad number and different type of paid receipts, e.g. hotel, food, gas, rental car, and airline tickets, in order to file a claim for reimbursement of the business person's expenses that may have accumulated over the trip. By having a uniquely identified financial card, e.g. a credit card or debit card, the business expenses financial transactions can be seamlessly integrated into an accounting software program, e.g. QuickBooks, Peachtree Accounting, Quicken, or tax software program, e.g. Turbo-Tax, Tax Cut. By selecting at least one destination and at least one format, a user could authorize that business expenses financial transactions be transmitted in order to maintain up-to-date financial records. For a large business, this process has the potential to eliminate or to reduce the number of staff involved in handling and processing business related expenses, to decrease concerns related to lost receipts, and to avoid the need to request duplicate expense receipts. Additional benefits may also include providing a quicker turn-around time for the business to issue a reimbursement check and improving the overall accuracy and timeliness of the business expense reconciliation process which ultimately could result in better management and improvement of the cash flow of the business.

A third problem involves the notification process for a client to activate or deactivate the monitoring of that client's financial transactions. Generally, clients may not want to have continuous monitoring and alerting of their financial transactions, e.g. credit card or debit card transactions. Instead, clients may want to activate monitoring and alerting before an event such as travel, when the perceived threat of identity theft is higher. The client would then deactivate monitoring and alerting after the termination of the event. It is predictable that in the rush to leave on a trip that the client may not remember to activate the monitoring until just as they are leaving the house and activating their home security system. Additionally the client may not remember the telephone number of the financial transaction monitoring system. If the home security system was enabled for notifying the security monitoring system to activate financial transaction monitoring and alerting, the client could simply activate the monitoring and alerting via the home security system as they were leaving.

These and other problems exist.

Previous attempts to use financial transaction systems to solve these and other problems include the following.

U.S. Pat. No. 5,708,422, issued to Blonder teaches an automated method for authorizing transaction based on customer identifier e.g. via two way pager—receives request for transaction authorization, and based on identifier determines whether to authorize it, and then communicates with customer who indicates consent to authorization and completion of transaction.

U.S. Pat. No. 5,878,337, issued to Joao teaches a financial transaction authorization, notification and security apparatus—processes point of sale request with checking for theft and credit levels to transmit signal to card holder device.

U.S. Pat. No. 5,903,830, issued to Joao teaches a financial transaction authorization, notification and security apparatus—processes point of sale request with checking for theft and credit levels to transmit signal to card holder device.

U.S. Pat. No. 5,914,472, issued to Foladare teaches a card users spending limit controller of monetary transaction authorizing system.

U.S. Pat. No. 6,047,270, issued to Joao teaches an account security providing apparatus for use in financial transaction, processes transaction on electric money account holder in conjunction with limitation and restriction.

U.S. Pat. No. 6,064,990, issued to Goldsmith teaches an account activity notifying method for use in financial institution computer system, involves transmitting electronic message to location identified by user contact information for financial account.

U.S. Pat. No. 6,327,348, issued to Walker teaches an authorization of credit card transactions controlling method.

U.S. Pat. No. 6,529,725 issued to Joao teaches a financial transaction authorization, notification and security apparatus—processes point of sale request with checking for theft and credit levels to transmit signal to card holder device.

U.S. Pat. No. 6,597,770, issued to Walker teaches an account based transaction authorization method involves enabling communication between account holder and user if account holder desires to communicate with user.

U.S. Pat. No. 6,685,087, issued to Brown teaches an authorities alerting method for credit card validation system, involves notifying authorities of suspected crime in progress, if confirmation code comprising duress code is received from vendor during card authorization.

U.S. Pat. No. 6,823,318, issued to Creswell teaches a goods/services, purchasing method for use in computer network e.g. Internet, involves sending confirmation number from vendor server to billing server if cancel code is not received from purchaser within preset time.

U.S. Pat. No. 6,792,323, issued to Krzyzanowski teaches a control server, or similar central processor, manages the distribution of data (including audio and video), voice, and control signals among a plurality of devices connected via a wired and/or wireless communications network. The devices include audio/visual devices (such as, televisions, monitors, PDAs, notepads, notebooks, MP3, portable stereo, etc.) as well as household appliances (such as, lighting, ovens, alarm clocks, etc.). The control server supports video/audio serving, telephony, messaging, file sharing, internetworking, and security. A portable controller allows a user to access and control the network devices from any location within a controlled residential and/or non-residential environment, including its surrounding areas. The controllers are enhanced to support location-awareness and user-awareness functionality.

While these patents and other previous methods have attempted to solve the above mentioned problems, none have utilized a security system to activate/deactivate financial transaction monitoring, used financial transactions to monitor agent status, or seamlessly update business expenses to accounting/tax software systems.

Therefore, a need exists for an improved financial transaction system.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a new system and method for financial transactions.

One area of application for the present invention is for communication of agent status in the field of intelligence/counter-intelligence operations and espionage work. One embodiment of the present invention is comprised of the steps of detecting in real time that a financial transaction has occurred on a uniquely marked account by comparing transaction data with account data, associating the transaction data with the account data to form alerting data, transmitting in real time the alerting data to at least one receiving system, receiving said alerting data, associating the alerting data with agent data and displaying agent data, agent location data and agent message.

Another area of application for the present invention is for the real-time processing of expenses, e.g. accounting-related data and documentation of business expenses, as well as tax data. One embodiment of the present invention is comprised of the steps of determining that a financial transaction is for an account marked for specialized data conversion and transmission, determining formats desired for the specialized data conversion and transmission, creating at least one formatted data, transmitting at least one formatted data by a communications method, receiving the formatted data, identifying software data base corresponding to the formatted data and updating the software data base with the formatted data. Examples of the software data base include QuickBooks, Quicken, Turbo Tax, Tax Cut, as well as proprietary accounting and tax software systems.

Another area of application for the present invention is for the notification process for a client to activate or deactivate the monitoring of that client's financial transactions. One embodiment of the present invention is comprised of the steps of keying an activation code into a security system, transmitting the activation code via non-internet means to a monitoring system, associating the activation code with stored client data, forming monitoring data for transmission to financial card monitoring system, transmitting the monitoring activation data to financial card monitoring system, receiving the monitoring activation data, processing the monitoring activation data, monitoring at least one client financial card account associated with the monitoring of activation data, detecting a transaction on the client financial card account and transmitting alerting data to client by the communication method. An example of the security system is a home security system, e.g. Brinks, ADT. An example of the financial card account is a credit card or debit card. This embodiment is additionally comprised of the steps to deactivate financial transaction monitoring as follows: keying an deactivation code into a security system, transmitting the deactivation code via non-internet means to a monitoring system, associating the deactivation code with stored client data, forming monitoring data for transmission to financial card monitoring system, transmitting the monitoring deactivation data to financial card monitoring system, receiving the monitoring deactivation data, processing the monitoring deactivation data and terminating the monitoring at least one client financial card account associated with the monitoring deactivation data.

One objective of the present invention is to provide a financial transaction system that enables the determining of an agent's status.

Another objective of the present invention is to provide a financial transaction system that enables the updating of financial transactions into accounting software systems.

Another objective of the present invention is to provide a financial transaction system that enables the updating of financial transactions into tax software systems.

Another objective of the present invention is to provide a financial transaction system that enables the activation/deactivation of financial transaction monitoring and alerting via a home security system.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further objects and advantages of the present invention will be apparent from the following detailed description of a presently preferred embodiment which is illustrated schematically in the accompanying drawings.

### DESCRIPTION OF THE SEVERAL VIEWS OF THE DRAWING

Other advantages and features of the invention are described with reference to exemplary embodiments, which are intended to explain and not to limit the invention, and are illustrated in the drawings in which:

FIG. 1 is a flow diagram of a process to initiate the activation of monitoring and alerting of a financial card using a security system according to a preferred embodiment of the present invention.

FIG. 2 is a flow diagram of a process to initiate the deactivation of monitoring and alerting of a financial card using a security system according to a preferred embodiment of the present invention.

FIG. 3 is a flow diagram of a process to monitor the status of an agent according to a preferred embodiment of the present invention.

FIG. 4 is a flow diagram of the first part of a process to integrate financial transactions into accounting or tax software systems according to a preferred embodiment of the present invention.

FIG. 5 is a flow diagram of the second part of a process to integrate financial transactions into accounting or tax software systems according to a preferred embodiment of the present invention.

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

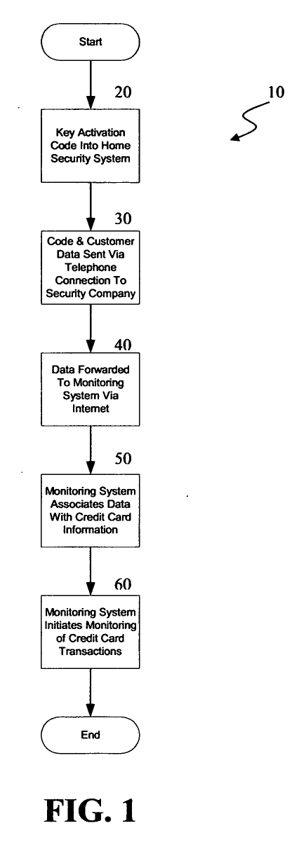

Referring now to FIG. 1, one embodiment of financial transaction system 10 is comprised of step 20, step 30, step 40, step 50 and step 60. In step 20, the client keys in the activation code in the client's home security system. This may be by way of one pre-set button on the security pad, or by a series of buttons on the security pad. In step 30 the activation code and customer data, e.g. home telephone number, is sent to the security company monitoring system, e.g., by dialing the system using the home telephone line. In step 40, the security monitoring system transmits activation data to the financial card monitoring and alerting system identifying the client. In step 50, the financial card monitoring and alerting system associates the activation data with the client's financial card. In step 60 the financial card monitoring and alerting system initiates the monitoring and alerting process for the client's financial card transactions.

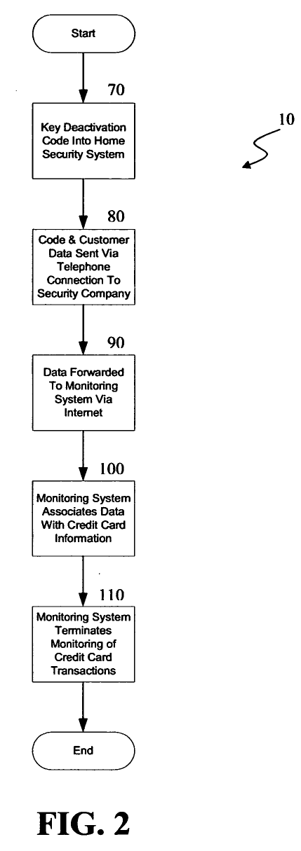

Referring now to FIG. 2, the embodiment of financial transaction system 10 shown in FIG. 1 is further comprised of step 70, step 80, step 90, step 100 and step 110. In step 70, the client keys in the deactivation code in the client's home security system. This may be by way of one pre-set button on the security pad, or by a series of buttons on the security pad. In step 80 the deactivation code and customer data, e.g. home telephone number, is sent to the security company monitoring system, e.g., by dialing the system using the home telephone line. In step 90, the security monitoring system transmits deactivation data to the financial card monitoring and alerting system identifying the client. In step 100, the financial card monitoring and alerting system associates the deactivation data with the client's financial card. In step 110 the financial card monitoring and alerting system terminates the monitoring and alerting process for the client's financial card transactions.

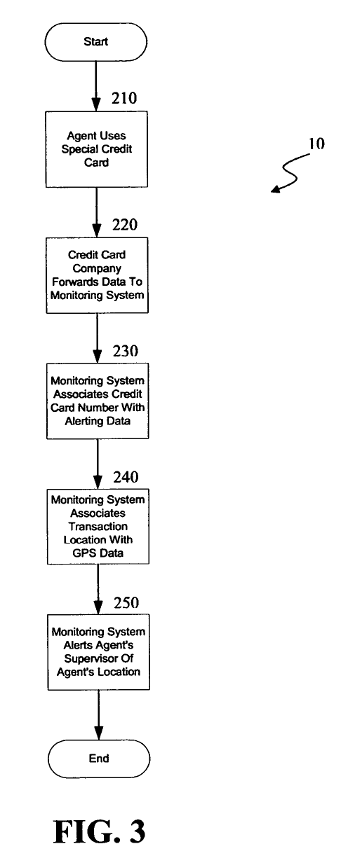

Referring now to FIG. 3, another embodiment of financial transaction system 10 is further comprised of step 210, step 220, step 230, step 240 and step 250. In step 210, an agent uses a uniquely identified financial card. In step 220, the financial card system detects in real time that a financial transaction has occurred on a uniquely marked account by comparing transaction data with account data, associates the transaction data with the account data to form alerting data, and transmits in real time the alerting data to an agent monitoring system. In step 230, the agent monitoring system associates the financial card data with the agent data. In step 240, the agent monitoring system associates the transaction location data with mapping data, e.g. GPS. In step 250, the agent monitoring system displays agent data, agent location data and agent message to the person in the agency monitoring the agent's activities.

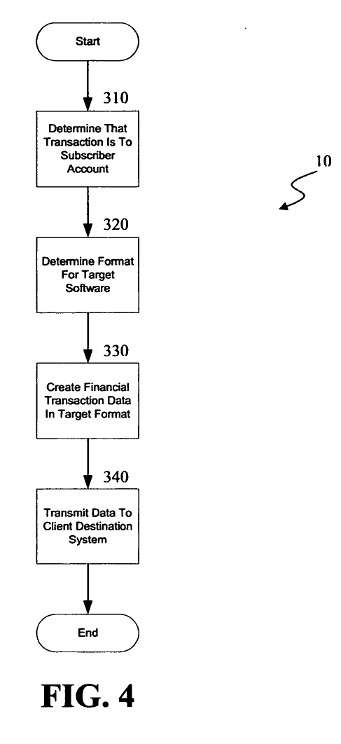

Referring now to FIG. 4, another embodiment of financial transaction system 10 is further comprised of step 310, step 320, step 330, step 340 and step 350. In step 310, the financial card system determines that a financial transaction is for an account marked for specialized data conversion and transmission. In step 320 the financial card system determines which formats are desired for the specialized data conversion and transmission. In step 330, the financial card system creates the formatted data. In step 340 the financial card system transmits the formatted data by a communications method, e.g. the Internet.

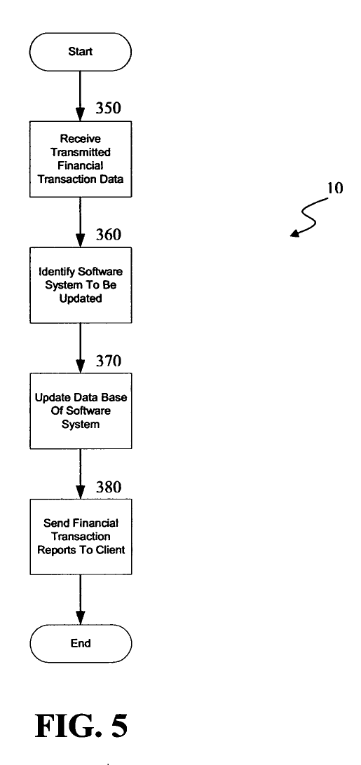

Referring now to FIG. 5, the embodiment of financial transaction system 10 shown in FIG. 4 is further comprised of step 350, step 360, step 370 and step 380. In step 350 the client software system receives the formatted data. In step 360 the client software system identifies which software data base is to be updated, e.g. by looking at the file type of the formatted data. In step 370, the client software system updates the software data base with the formatted data. In step 380, the client software system sends financial transaction reports to the client.

Although the invention has been described herein with specific reference to a presently preferred and additional embodiments thereof, it will be appreciated by those skilled in the art that various modifications, deletions, and alterations may be made to such preferred embodiment without departing from the spirit and scope of the invention. Accordingly, it is intended that all reasonably foreseeable additions, modifications, deletions and alterations be included within the scope of the invention as defined in the following claims.

What is claimed is:

1. A financial transaction system comprising the steps of:
keying an activation code into a security system;
transmitting said activation code via non-internet means to a monitoring system;
associating said activation code with stored client data;
forming client monitoring activation data for transmission to financial card monitoring system; and,
transmitting said client monitoring activation data to financial card monitoring system.

2. The financial transaction system of claim 1, further comprising:
receiving said client monitoring activation data;
processing said client monitoring activation data; and,
monitoring at least one client financial card account associated with said client monitoring activation data.

3. The financial transaction system of claim 2, further comprising:
detecting a transaction on said at least one client financial card account; and,
transmitting alerting data to client by at least one communication method.

4. The financial transaction system of claim 3, wherein said security system is a home security system and wherein said at least one financial card account is a credit card account.

5. The financial transaction system of claim 3, wherein said security system is a home security system and wherein said at least one financial card account is a debit card account.

6. A financial transaction system comprising the steps of:
keying a deactivation code into a security system;
transmitting said deactivation code via non-internet means to a monitoring system;
associating said deactivation code with stored client data;
forming client monitoring deactivation data for transmission to financial card monitoring system; and,
transmitting said client monitoring deactivation data to financial card monitoring system.

7. The financial transaction system of claim 6, further comprising:
receiving said client monitoring deactivation data;
processing said client monitoring deactivation data; and,
terminating the monitoring at least one client financial card account associated with said client monitoring deactivation data.

8. A financial transaction system comprising the steps of:
detecting in real time that a financial transaction has occurred on a uniquely marked account by comparing transaction data with account data;
associating said transaction data with said account data to form alerting data; and,
transmitting in real time said alerting data to at least one receiving system.

9. The financial transaction system of claim 8, further comprising:
receiving said alerting data;
associating said alerting data with agent data; and,
displaying agent data, agent location data and agent message.

10. A financial transaction system comprising the steps of:
determining that a financial transaction is for an account marked for specialized data conversion and transmission;
determining formats desired for said specialized data conversion and transmission;
creating at least one formatted data; and,
transmitting at least one formatted data by at least one communications method.

11. The financial transaction system of claim 10, further comprising:
receiving said at least one formatted data;
identifying a software data base corresponding to said at least one formatted data; and,
updating said software data base with said at least one formatted data.

12. The financial transaction system of claim 11, wherein said software data base is a tax software data base.

13. The financial transaction system of claim 11, wherein said software data base is an accounting system data base.
